(19) United States
(12) Patent Application Publication
(10) Pub. No.: US 2019/0276218 A1
(43) Pub. Date: Sep. 12, 2019

(54) ANTIMICROBIAL GAS RELEASING AGENTS AND SYSTEMS AND METHODS FOR USING THE SAME

(71) Applicant: CSP Technologies, Inc., Auburn, AL (US)

(72) Inventors: Jonathan R. FREEDMAN, Auburn, AL (US); Deepti S. GUPTA, Glenn Allen, VA (US); Michael A. JOHNSTON, Marietta, GA (US); John BELFANCE, Phenix City, AL (US)

(21) Appl. No.: 16/349,578

(22) PCT Filed: Nov. 13, 2017
(86) PCT No.: PCT/US2017/061389

§ 371 Date: May 13, 2019

Related U.S. Application Data
(60) Provisional application No. 62/421,348, filed on Nov. 13, 2016.

(51) Int. Cl. B65D 81/28; A01N 59/00; A23B 4/16; B65D 25/14; A23B 7/152; A23L 3/3445; B65D 51/28; B65D 1/34; B32B 1/02; B32B 27/18; B32B 27/30

(52) U.S. Cl. CPC B65D 81/28; B32B 2439/70; A23B 4/16; B65D 25/14; A23B 7/152; A23L 3/3445; B65D 51/28; B65D 1/34; B32B 1/02; B32B 27/18; B32B 27/306; A23V 2002/00; B32B 2264/104; B32B 2307/7145; A01N 59/00

(57) ABSTRACT

A system and method are disclosed for inhibiting or preventing the growth of microbes and/or for killing microbes in a closed package or container in which a good (optionally a food product) is held or stored. The system and method optionally include use of an entrained polymer article, preferably a film, that includes an antimicrobial releasing agent.

### CROSS-REFERENCE TO RELATED APPLICATIONS

This application claims priority under 35 U.S.C. § 119(e) from U.S. Provisional Patent Application No. 62/421,348, entitled “ENTRAINED POLYMERS WITH ANTIMICROBIAL RELEASING AGENTS”, filed on Nov. 13, 2016, the contents of which are incorporated herein by reference in their entirety.

### BACKGROUND OF THE INVENTION

### 1. Field of the Invention

This invention relates to systems and methods for reducing and preventing the growth of microbes, or for killing microbes, within an interior space of a container and/or on product/good that is stored in the package. More particularly, the invention relates to systems and methods for reducing and preventing growth of microbes, or for killing microbes, e.g., in food containers, using polymers entrained with antimicrobial releasing agents.

### 2. Description of Prior Art

There are many items that are preferably stored, shipped and/or utilized in an environment that must be controlled and/or regulated. For example, in the moisture control field, containers and/or packages having the ability to absorb excess moisture trapped therein have been recognized as desirable. Likewise, in packaging products that carry a risk of contamination, e.g., food, it may be desirable to control the growth and proliferation of microbes.

Food products, particularly sliced or cut fresh foodstuffs such as meat, poultry, fruit, and vegetables are typically stored and sold in a supporting container, e.g., tray, that is overwrapped by a transparent plastic film, enabling visual inspection of the food products. These food products generally produce an exudate (i.e., juices), which can be a source for the growth of microbial agents. In addition, contamination of processing equipment or other surfaces with which the food products come into contact may remain with the food and proliferate while packaged. Similarly, food products may be contaminated even before the packaging process. For example, a tomato may have an opening in its skin through which unwanted microorganisms enter and replicate. Breakdown in the food handling process and/or cold chain management (e.g., refrigeration during food transport breaks for several hours) can allow microbial growth of contaminated food, potentially leading to outbreaks of food borne illness. Regardless of the source or nature of microbial contamination in food, the shelf-life and safety of the contaminated food products is affected by contamination and proliferation of microbes.

One way that the food industry has addressed preservation of foodstuffs is by including food grade preservatives as a component of the food, such as potassium sorbate, sodium benzoate and nitrites. However, such preservatives are regarded by some in the health field and consumers as being unnatural and presenting health risks. Moreover, it is not practical to use such preservatives with non-processed foods, for example fresh fruits or vegetables.

Another way that the food industry has addressed food preservation is to utilize antimicrobial agents that directly contacts the food as a component in packaging material. However, such direct contact may be undesirable in some applications.

For certain applications, it is desirable to provide antimicrobial agents to release antimicrobial gas into a headspace of the food product package or container to control the growth of microbes, as compared to a solid or liquid component that requires direct contact with the stored food in order to be effective. However, there are challenges with providing the antimicrobial gas in the headspace. One such challenge is attaining a desired release profile of antimicrobial gas within the headspace during a designated time period. Failure to attain the appropriate release profile for a given product may result in a failure to achieve the desired shelf life for that product. Thus, there exists a need for improved delivery of antimicrobial agents to control, reduce and substantially destroy microbial contamination in food packaging as well as other applications, such as but not limited to, packaging of sterilized disposable medical devices. A challenge in meeting this need is maintaining a balance between providing sufficient antimicrobial gas in the package headspace to effectively control and/or kill pathogens while not “overdosing” the package headspace, which could adversely affect the quality of the product, e.g., by organoleptic degradation.

### SUMMARY OF THE INVENTION

Accordingly, in one aspect, the invention provides a system to inhibit or prevent growth of microbes and/or to kill microbes in a closed container having a good that is located therein. The system includes a container including a bottom surface, a top opening, one or more sidewalls extending in a vertical direction from the bottom surface to the top opening, an interior space formed by the one or more sidewalls, a headspace formed by the interior space that is not occupied by the good, and a cover to close and/or seal the container. The system also includes at least one entrained polymer article located within the interior space that includes a monolithic material, which includes a base polymer, and an antimicrobial releasing agent configured to release a released antimicrobial gas. The system further includes a selected material present in the interior space to activate the release of the released antimicrobial gas.

In another aspect, the invention provides a method for inhibiting or preventing the growth of microbes and/or for killing microbes in a closed container having a good located therein. The method includes forming at least one entrained polymer article, which includes obtaining a base polymer, and combining an antimicrobial releasing agent with the base polymer to form a monolithic material, wherein the antimicrobial releasing agent is configured to release a released antimicrobial material in gas form upon being activated by a selected material. The method also includes obtaining a container that includes a bottom surface, a top opening, one or more sidewalls extending in a vertical direction from the bottom surface to the top opening, an interior space formed by the one or more sidewalls, a headspace formed by the interior space that is not occupied by the good, and a cover to close and/or seal the container. The method further includes positioning the at least one entrained polymer article within the interior space of the container; placing the good in the container; covering the container; presenting the selected material in the interior space of the container; and releasing the released antimicrobial material within the interior space in a concentration effective for reducing or preventing the growth of microbes and/or for killing microbes present in and/or on the good.

In another aspect, a package is provided for inhibiting or preventing growth of microbes and/or for killing microbes in a closed container having a product located therein. The package includes a closed container defining an interior space therein. A product (optionally a food product) is provided within the interior space. A headspace is formed within a volume of the interior space that is not occupied by the product. An antimicrobial releasing agent is disposed within the interior space, the antimicrobial releasing agent releasing chlorine dioxide gas into the headspace by reaction of moisture with the antimicrobial releasing agent. The antimicrobial releasing agent is provided in an amount that releases the chlorine dioxide gas to provide a headspace concentration of from 10 parts per million (PPM) to 35 PPM for a period of 16 hours to 36 hours, optionally from 15 PPM to 30 PPM for a period of 16 hours to 36 hours, optionally from 15 PPM to 30 PPM for a period of about 24 hours.

Optionally, in any embodiment, when the product is provided within the interior space, the product is contaminated by at least one type of pathogen. The antimicrobial releasing agent provides a controlled release of chlorine dioxide gas to effectuate, after a span of 13 days from when the product is provided within the interior space and under storage conditions of 7° C., at least a 2 log base 10 reduction in colony forming units per gram (CFU/g), optionally at least a 3 log base 10 reduction in CFU/g, of the at least one type of pathogen, optionally at least a 4 log base 10 reduction in CFU/g, of the at least one type of pathogen. Optionally, the at least one pathogen is Salmonella, E. coli, Listeria and/or Geotrichum.

Optionally, if the product is a food product and the amount of antimicrobial releasing agent and/or chlorine dioxide gas is present in an amount sufficient to effectuate the at least 2 log base 10 reduction in CFU/g, (or at least 3 log base 10 or 4 log base 10 reduction in CFU/g), of the at least one type of pathogen, such efficacy does not come at the expense of organoleptic degradation of the food product. For example the food product is not bleached or otherwise discolored.

Optionally, in any embodiment, the antimicrobial releasing agent is provided in at least one entrained polymer article located within the interior space. The entrained polymer article is a monolithic material that includes a base polymer, the antimicrobial releasing agent and optionally a channeling agent. Preferably, such entrained polymer is provided as a film having a thickness of from 0.1 mm to 1.0 mm, preferably from 0.2 mm to 0.6 mm, optionally about 0.3 mm Preferably, such film is provided above the midline (preferably at least ⅔ or ¾) of the container sidewalls, which inventors have found helps to attain a desired antimicrobial gas release profile.

Optionally, in any embodiment, the antimicrobial releasing agent is a powdered mixture comprising an alkaline metal chlorite, preferably sodium chlorite. Optionally, the powdered mixture further comprises at least one catalyst, optionally sulfuric acid clay, and at least one humidity trigger, optionally calcium chloride.

Optionally, in any embodiment, a method is provided for inhibiting or preventing the growth of microbes and/or for killing microbes in a closed container having a food product located therein. The method includes providing a closed container defining an interior space therein and a food product within the interior space. A headspace is formed within a volume of the interior space that is not occupied by the product. An antimicrobial releasing agent (such as that disclosed in this Summary section and elsewhere in this specification) is provided in the interior space. The agent releases an antimicrobial gas into the headspace by reaction of moisture with the antimicrobial releasing agent. The antimicrobial releasing agent is provided in an amount sufficient to release the antimicrobial gas to provide a desired headspace concentration of the antimicrobial gas over a predetermined amount of time. According to the method, if the product is contaminated by at least one type of pathogen at the time the product is provided within the interior space, the antimicrobial releasing agent optionally provides a controlled release of antimicrobial gas to effectuate, after a span of 13 days under storage conditions of 7° C., at least a 2 log base 10 reduction in CFU/g, optionally at least a 3 log base 10 reduction in CFU/g, optionally at least a 4 log base 10 reduction in CFU/g, of the at least one type of pathogen. Preferably, this method effectuates the reduction without causing organoleptic degradation of the food product, for example without bleaching or otherwise causing discoloration of the food product. Preferably, the antimicrobial releasing agent is provided in an entrained polymer film, for example as described herein.

Optionally, in any embodiment of a package described herein, an aspect of the invention may include use of the package for storing a food product, wherein the food product exudes moisture that activates the antimicrobial releasing agent to release chlorine dioxide gas in the headspace. This use may attain desired headspace antimicrobial gas concentrations as described herein. This use may effectuate, after a span of 13 days from when the product is provided within the interior space and under storage conditions of 7° C., at least a 2 log base 10 reduction in colony forming units per gram (CFU/g), optionally at least a 3 log base 10 reduction in CFU/g, optionally at least a 4 log base 10 reduction in CFU/g, of the at least one type of pathogen. This is preferably done without causing organoleptic degradation of the food product, for example without bleaching or otherwise discoloring the food product.

### BRIEF DESCRIPTION OF THE DRAWINGS

The invention will be described in conjunction with the following drawings in which like reference numerals designate like elements and wherein:

FIG. 1 is a perspective view of a plug formed of an entrained polymer according to an optional embodiment of the present invention.

FIG. 2 is a cross section taken along line 2-2 of FIG. 1;

FIG. 3 is a cross section similar to that of FIG. 2, showing a plug formed of another embodiment of an entrained polymer according to an optional embodiment of the present invention;

FIG. 4 is a schematic illustration of an entrained polymer according to an optional embodiment of the present invention, in which the active agent is an antimicrobial gas releasing material that is activated by contact with a selected material (e.g., moisture).

FIG. 5 is a cross sectional view of a sheet or film formed of an entrained polymer according to an optional embodiment of the present invention, adhered to a barrier sheet substrate.

FIG. 6 is a cross section of a package that may be formed using an entrained polymer according to an optional embodiment of the present invention.

FIG. 7 is a perspective view of an exemplary package incorporating entrained polymer films according to an optional aspect of the present invention.

FIGS. 8A and 8B are plots comparing Geotrichum Growth on contaminated tomatoes stored in packages respectively with and without use of antimicrobial entrained polymer film.

FIG. 9 is a plot showing the measured amount of ClO₂ (chlorine dioxide) provided within a headspace of a container including entrained polymer film, in accordance with certain embodiments of the invention.

FIG. 10 is a plot showing the measured amount of ClO₂ provided within a headspace of a container including an entrained polymer film positioned at varying heights on the sidewall, in accordance with certain embodiments of the invention.

FIG. 11 is a plot showing the log CFU/gram reduction in Salmonella for foodstuff stored in containers with an entrained polymer film being positioned therein, in accordance with certain embodiments, as compared to containers absent of the entrained polymer film.

FIG. 12 is a plot showing the log CFU/gram reduction in E. coli for foodstuff stored in containers with an entrained polymer film being positioned therein, in accordance with certain embodiments, as compared to containers absent of the entrained polymer film.

FIG. 13 is a plot showing the log CFU/gram reduction in Listeria for foodstuff stored in containers with an entrained polymer film being positioned therein, in accordance with certain embodiments, as compared to containers absent of the entrained polymer film.

FIG. 14 is a plot showing the measured amounts of ClO₂ provided within a headspace of a container depending on the amount of entrained antimicrobial polymer film provided in the container.

### DETAILED DESCRIPTION OF PREFERRED EMBODIMENTS

### Definitions

As used herein, the term “active” is defined as capable of acting on, interacting with or reacting with a selected material (e.g., moisture or oxygen) according to the invention. Examples of such actions or interactions may include absorption, adsorption or release of the selected material. Another example of “active”, which is pertinent to a primary focus of the present invention is an agent capable of acting on, interacting with or reacting with a selected material in order to cause release of a released material.

As used herein, the term “active agent” is defined as a material that (1) is preferably immiscible with the base polymer and when mixed and heated with the base polymer and the channeling agent, will not melt, i.e., has a melting point that is higher than the melting point for either the base polymer or the channeling agent, and (2) acts on, interacts or reacts with a selected material. The term “active agent” may include but is not limited to materials that absorb, adsorb or release the selected material(s). The active agents of primary focus in this specification are those that release antimicrobial gas(es), preferably chlorine dioxide gas.

The term “antimicrobial releasing agent” refers to an active agent that is capable of releasing a released antimicrobial material, e.g. in gas form. This active agent may include an active component and other components (such as a catalyst and trigger) in a formulation (e.g., powdered mixture) configured to release the antimicrobial gas. A “released antimicrobial material” is a compound that inhibits or prevents the growth and proliferation of microbes and/or kills microbes, e.g., chlorine dioxide gas. The released antimicrobial material is released by the antimicrobial releasing agent. By way of example only, an antimicrobial releasing agent may be triggered (e.g., by chemical reaction or physical change) by contact with a selected material (such as moisture). For example, moisture may react with an antimicrobial releasing agent to cause the agent to release a released antimicrobial material.

As used herein, the term “base polymer” is a polymer optionally having a gas transmission rate of a selected material that is substantially lower than, lower than or substantially equivalent to, that of the channeling agent. By way of example, such a transmission rate is a water vapor transmission rate in embodiments where the selected material is moisture and the active agent is an antimicrobial gas releasing agent that is activated by moisture. This active agent may include an active component and other components in a formulation configured to release the antimicrobial gas. The primary function of the base polymer is to provide structure for the entrained polymer.

Suitable base polymers for use in the invention include thermoplastic polymers, e.g., polyolefins such as polypropylene and polyethylene, polyisoprene, polybutadiene, polybutene, polysiloxane, polycarbonates, polyamides, ethylene-vinyl acetate copolymers, ethylene-methacrylate copolymer, poly(vinyl chloride), polystyrene, polyesters, polyanhydrides, polyacrylianitrile, polysulfones, polyacrylic ester, acrylic, polyurethane and polyacetal, or copolymers or mixtures thereof.

In certain embodiments, the channeling agent has a water vapor transmission rate of at least two times that of the base polymer. In other embodiments, the channeling agent has a water vapor transmission rate of at least five times that of the base polymer. In other embodiments, the channeling agent has a water vapor transmission rate of at least ten times that of the base polymer. In still other embodiments, the channeling agent has a water vapor transmission rate of at least twenty times that of the base polymer. In still another embodiment, the channeling agent has a water vapor transmission rate of at least fifty times that of the base polymer. In still other embodiments, the channeling agent has a water vapor transmission rate of at least one hundred times that of the base polymer.

As used herein, the term “channeling agent” or “channeling agents” is defined as a material that is immiscible with the base polymer and has an affinity to transport a gas phase substance at a faster rate than the base polymer. Optionally, a channeling agent is capable of forming channels through the entrained polymer when formed by mixing the channeling agent with the base polymer. Optionally, such channels are capable of transmitting a selected material through the entrained polymer at a faster rate than in solely the base polymer.

As used herein, the term “channels” or “interconnecting channels” is defined as passages formed of the channeling agent that penetrate through the base polymer and may be interconnected with each other.

As used herein, the term “entrained polymer” is defined as a monolithic material formed of at least a base polymer with an active agent and optionally also a channeling agent entrained or distributed throughout. An entrained polymer thus includes two-phase polymers (without a channeling agent) and three-phase polymers (with a channeling agent).

As used herein, the term “monolithic,” “monolithic structure” or “monolithic composition” is defined as a composition or material that does not consist of two or more discrete macroscopic layers or portions. Accordingly, a “monolithic composition” does not include a multi-layer composite.

As used herein, the term “phase” is defined as a portion or component of a monolithic structure or composition that is uniformly distributed throughout, to give the structure or composition its monolithic characteristics.

As used herein, the term “selected material” is defined as a material that is acted upon, by, or interacts or reacts with an active agent and is capable of being transmitted through the channels of an entrained polymer. For example, in embodiments in which a releasing material is the active agent, the selected material may be moisture that reacts with or otherwise triggers the active agent to release a releasing material, such as an antimicrobial gas.

As used herein, the term “three phase” is defined as a monolithic composition or structure comprising three or more phases. An example of a three phase composition according to the invention is an entrained polymer formed of a base polymer, active agent, and channeling agent. Optionally, a three phase composition or structure may include an additional phase, e.g., a colorant, but is nonetheless still considered “three phase” on account of the presence of the three primary functional components.

Furthermore, the terms “package,” “packaging” and “container” may be used interchangeably herein to indicate an object that holds or contains a good, e.g., food product and foodstuffs. Optionally, a package may include a container with a product stored therein. Non-limiting examples of a package, packaging and container include a tray, box, carton, bottle receptacle, vessel, pouch and flexible bag. A pouch or flexible bag may be made from, e.g., polypropylene or polyethylene. The package or container may be closed, covered and/or sealed using a variety of mechanisms including a cover, a lid, lidding sealant, an adhesive and a heat seal, for example. The package or container is composed or constructed of various materials, such as plastic (e.g., polypropylene or polyethylene), paper, Styrofoam, glass, metal and combinations thereof. In one optional embodiment, the package or container is composed of a rigid or semi-rigid polymer, optionally polypropylene or polyethylene, and preferably has sufficient rigidity to retain its shape under gravity.

### Exemplary Entrained Polymers

Conventionally, desiccants, oxygen absorbers and other active agents have been used in raw form, e.g., as loose particulates housed in sachets or canisters within packaging, to control the internal environment of the package. For many applications, it is not desired to have such loosely stored active substances. Thus, the present application provides active entrained polymers comprising active agents, wherein such polymers can be extruded and/or molded into a variety of desired forms, e.g., container liners, plugs, film sheets, pellets and other such structures. Optionally, such active entrained polymers may include channeling agents, such as polyethylene glycol (PEG), which form channels between the surface of the entrained polymer and its interior to transmit a selected material (e.g., moisture) to the entrained active agent (e.g., desiccant to absorb the moisture). As explained above, entrained polymers may be two phase formulations (i.e., comprising a base polymer and active agent, without a channeling agent) or three phase formulations (i.e., comprising a base polymer, active agent and channeling agent). Entrained polymers are described, for example, in U.S. Pat. Nos. 5,911,937, 6,080,350, 6,124,006, 6,130,263, 6,194,079, 6,214,255, 6,486,231, 7,005,459, and U.S. Pat. Pub. No. 2016/0039955, each of which is incorporated herein by reference as if fully set forth.

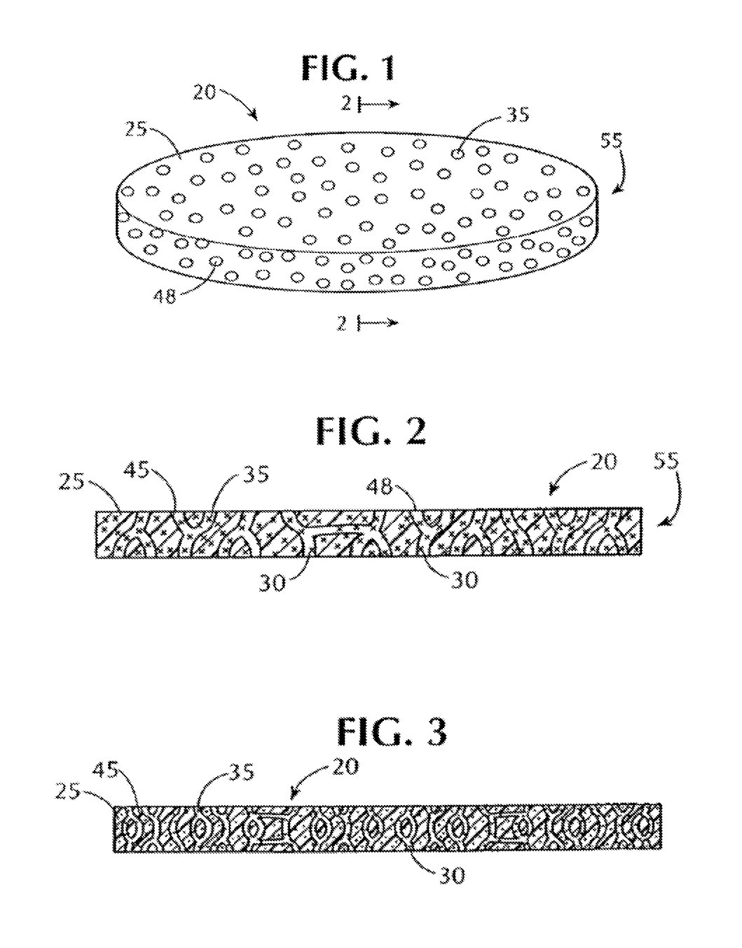

FIGS. 1-6 illustrate exemplary entrained polymers 20 and various packaging assemblies formed of entrained polymers according to certain embodiments of the invention. The entrained polymers 20 each include a base polymer 25, optionally a channeling agent 35 and an active agent 30. As shown, the channeling agent 35 forms interconnecting channels 45 through the entrained polymer 20. At least some of the active agent 30 is contained within these channels 45, such that the channels 45 communicate between the active agent 30 and the exterior of the entrained polymer 20 via channel openings 48 formed at outer surfaces of the entrained polymer 25. The active agent 30 can be, for example, any one of a variety of releasing materials, as described in further detail below. While a channeling agent, e.g., 35, is preferred, the invention broadly includes entrained polymers that optionally do not include a channeling agent.

Suitable channeling agents include polyglycol such as polyethylene glycol (PEG), ethylene-vinyl alcohol (EVOH), polyvinyl alcohol (PVOH), glycerin polyamine, polyurethane and polycarboxylic acid including polyacrylic acid or polymethacrylic acid. Alternatively, the channeling agent 35 can be, for example, a water insoluble polymer, such as a propylene oxide polymerisate-monobutyl ether, which is commercially available under the trade name Polyglykol B01/240, produced by CLARIANT. In other embodiments, the channeling agent could be a propylene oxide polymerisate monobutyl ether, which is commercially available under the trade name Polyglykol B01/20, produced by CLARIANT, propylene oxide polymerisate, which is commercially available under the trade name Polyglykol D01/240, produced by CLARIANT, ethylene vinyl acetate, nylon 6, nylon 66, or any combination of the foregoing.

Entrained polymers with antimicrobial releasing agents are further described below.

### Antimicrobial Releasing Agents and Optional Entrained Polymer Formulations Incorporating the Same

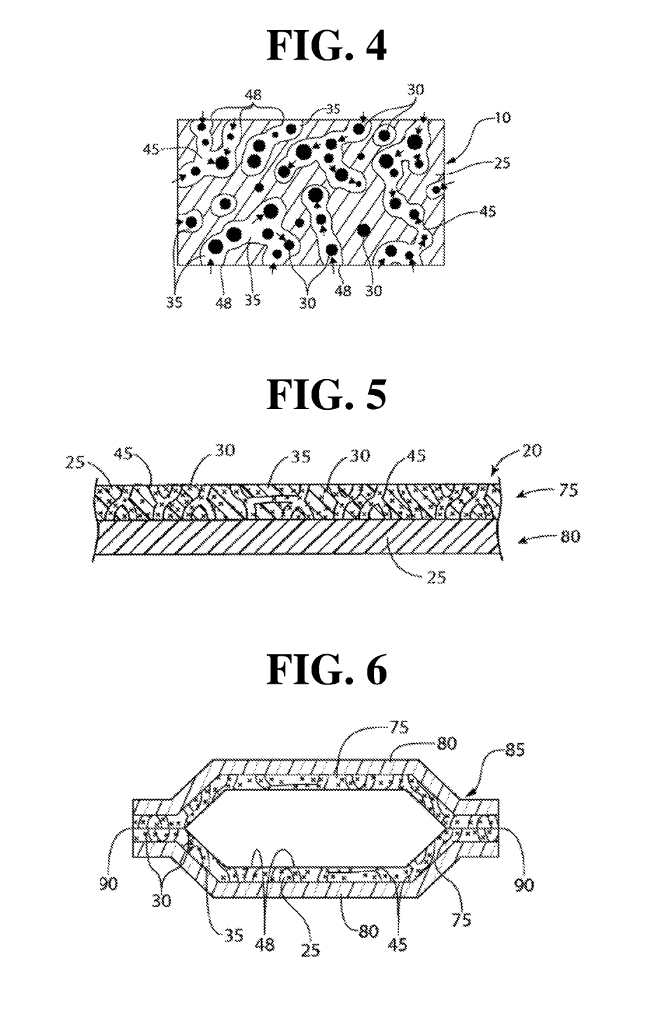

Suitable active agents according to the invention include antimicrobial releasing agents. FIG. 4 illustrates an embodiment of an entrained polymer 10 according to the invention, in which the active agent 30 is an antimicrobial releasing agent. The arrows indicate the path of a selected material, for example moisture or another gas, from an exterior of the entrained polymer 10, through the channels 45, to the particles of active agent 30 (in this case, an antimicrobial releasing agent). Optionally, the antimicrobial releasing agent reacts with or is otherwise triggered or activated by the selected material (e.g., by moisture) and in response releases a released antimicrobial material, preferably in gas form.

The antimicrobial agents useful herein include volatile antimicrobial releasing agents, non-volatile antimicrobial releasing agents and combinations thereof.

The term “volatile antimicrobial releasing agent” includes any compound that when it comes into contact with a fluid (e.g., water or the juice from a food product), produces a gas and/or gas phase such as vapor of released antimicrobial agent. As will be discussed in greater detail below, the volatile antimicrobial releasing agent is generally used in a closed system so that the released antimicrobial material (gas and/or vapor) does not escape. Examples of volatile antimicrobial releasing agents include, but are not limited to, origanum, basil, cinnamaldehyde, chlorine dioxide-releasing agents (e.g., a combination of sodium chlorite, a catalyst and a trigger), carbon dioxide-releasing agents, ozone-releasing agents, vanillin, vanillic acid, cilantro oil, clove oil, horseradish oil, mint oil, rosemary, sage, thyme, wasabi or an extract thereof, a bamboo extract, an extract from grapefruit seed, an extract of Rheum palmatum, an extract of coptis chinesis, lavender oil, lemon oil, eucalyptus oil, peppermint oil, Cananga odorata, Cupressus sempervirens, Curcuma longa, Cymbopogon citratus, Eucalyptus globulus, Pinus radiate, Piper crassinervium, Psidium guayava, Rosmarinus officinalis, Zingiber officinale, thyme, thymol, allyl isothiocyanate (AIT), hinokitiol, carvacrol, eugenol, α-terpinol, sesame oil, or any combination of the foregoing compounds.

The term “non-volatile antimicrobial agent” includes any compound that when it comes into contact with a fluid (e.g., water or the juice from a food product), produces minimal to no vapor of antimicrobial agent. Examples of non-volatile antimicrobial agents include, but are not limited to, ascorbic acid, a sorbate salt, sorbic acid, citric acid, a citrate salt, lactic acid, a lactate salt, benzoic acid, a benzoate salt, a bicarbonate salt, a chelating compound, an alum salt, nisin, ε-polylysine 10%, methyl and/or propyl parabens, or any combination of the foregoing compounds. The salts include the sodium, potassium, calcium, or magnesium salts of any of the compounds listed above. Specific examples include calcium sorbate, calcium ascorbate, potassium bisulfite, potassium metabisulfite, potassium sorbate, or sodium sorbate.

Preferred features of antimicrobial releasing agents used according to an aspect of the present invention include any one or more of the following characteristics: (1) they volatize at refrigerated temperatures; (2) they are food safe and edible in finished form; (3) they may be incorporated safely into an entrained polymer formulation or other mechanism for release; (4) they are shelf stable in long term storage conditions; (5) they release the released antimicrobial material only once a package in which the agent is disposed, is sealed with product disposed in the package; (6) they do not affect a stored food product organoleptically when they are formulated and configured to achieve a desired release profile within the package; and (7) they are preferably acceptable under applicable governmental regulations and/or guidelines pertaining to food packaging and finished food labeling.

### Chlorine Dioxide Releasing Antimicrobial Releasing Agents

In one aspect of the invention, preferred antimicrobial releasing agents are volatile antimicrobial agents that release chlorine dioxide (ClO₂) in gas form as the released antimicrobial material. For example, the antimicrobial releasing agent may be a compound or formulation comprising an alkaline chlorite, such as, e.g. sodium chlorite or potassium chlorite, a catalyst and a trigger (e.g., in the form of a powder) which in combination are triggered or activated by moisture to cause the agent to release chlorine dioxide. One exemplary antimicrobial releasing agent is provided under the brand ASEPTROL 7.05 by BASF Catalysts LLC. This material and preparation of the same is described in U.S. Pat. No. 6,676,850, which is incorporated by reference in its entirety. Example 6 of the aforementioned patent describes a formulation that is particularly suitable as an antimicrobial releasing agent, according to an optional aspect of the invention.

Optionally, a suitable antimicrobial releasing agent, which is based on Example 6 of U.S. Pat. No. 6,676,850 and is configured to release chlorine dioxide gas upon activation by moisture, may be prepared as follows.

The antimicrobial releasing agent includes a formulation comprising sodium chlorite (as the active component), abase catalyst and a trigger. The catalyst and trigger preparations are made separately, then combined together and ultimately combined with the sodium chlorite.

The base catalyst is optionally made by first preparing a 25-30 wt. % sodium silicate solution (SiO₂:Na₂O proportion of 2.0 to 3.3 by weight). That solution is mixed into an aqueous slurry of 28-44 wt. % Georgia Kaolin Clay (particle size diameter of about 80% less than one micrometer), wherein the sodium silicate solution is 2 wt. % of the slurry. The slurry is oven dried at 100° C. to generate agglomerates or microspheres of about 70 μm in size. 300 g of these microspheres are impregnated with 280 g of 2.16N sulfuric acid solution. That mixture is then dried at 100° C. Next, the dried mixture undergoes a calcine process at 350° C. for 3 hours, followed by an additional calcine process at 300° C. in a sealed glass jar with the seal wrapped with tape. This mixture forms the base catalyst.

Next, 84.6 g of the base catalyst are mixed with 10.1 g of the trigger, dry calcium chloride. This base catalyst and trigger mixture is ground with mortar and pestle at ambient room temperature. This mixture is dried for 2 hours at 200° C. The base catalyst and trigger mixture is then cooled to room temperature in a sealed glass jar with tape wrapped around the seal.

Finally, the base catalyst and trigger mixture is combined with 5.3 g of sodium chlorite (which is the active component of the active agent). The full mixture is then ground with mortar and pestle at ambient room temperature, thus forming an optional embodiment of an antimicrobial releasing agent. The antimicrobial releasing agent is then deposited in a sealed glass jar with tape wrapped around the seal to preserve it and keep it essentially free of moisture, which would prematurely activate it (to release chlorine dioxide gas).

Optionally, the antimicrobial releasing agent is a component of an entrained polymer, preferably a three phase polymer comprising the active agent (e.g., 40%-70% by weight), a base polymer and a channeling agent. Optionally, such entrained polymer is in the form of a film disposed within sealed packaging containing fresh foodstuffs, e.g., meat or produce.

It is generally believed that the higher the antimicrobial releasing agent concentration in an entrained polymer mixture, the greater the absorption, adsorption or releasing capacity of the final composition. However, too high an active agent concentration may cause the entrained polymer to be too brittle. This may also cause the molten mixture of active agent, base polymer and (if used) channeling agent to be more difficult to either thermally form, extrude or injection mold. In one embodiment, the antimicrobial releasing agent loading level or concentration can range from 10% to 80%, preferably 40% to 70%, more preferably from 40% to 60%, and even more preferably from 45% to 55% by weight with respect to the total weight of the entrained polymer. Optionally, the channeling agent may be provided in a range of 2% to 10% by weight, preferably about 5% by weight. Optionally, the base polymer may range from 10% to 50% by weight of the total composition, preferably from 20% to 35% by weight. Optionally, a colorant is added, e.g., at about 2% by weight of the total composition.

In one embodiment, an entrained polymer may be a three phase formulation including 50% by weight of ASEPTROL 7.05 antimicrobial releasing agent in the form of the powdered mixture, 38% by weight ethyl vinyl acetate (EVA) as a base polymer and 12% by weight polyethylene glycol (PEG) as a channeling agent.

FIG. 1 shows a plug 55 constructed of an entrained polymer 20, in accordance with certain embodiments of the invention. The plug 55 may be placed inside of a container. As aforementioned, the entrained polymer 20 includes a base polymer 25, a channeling agent 35 and an active agent 30.

FIG. 2 shows a cross-sectional view of the plug 55 shown in FIG. 1. In addition, FIG. 2 shows that the entrained polymer 20 has been solidified such that the channeling agent 35 forms interconnecting channels 45 to establish passages throughout the solidified plug 55. At least some of the active agent 30 is contained within the channels 45, such that the channels 45 communicate between the active agent 30 and the exterior of the entrained polymer 20 via channel openings 48 formed at outer surfaces of the entrained polymer 25.

FIG. 3 illustrates an embodiment of a plug 55 having similar construction and makeup to the plug 55 of FIG. 2, where interconnecting channels 45 are finer as compared to those shown in FIG. 2. This can result from the use of a dimer agent (i.e., a plasticizer) together with a channeling agent 35. The dimer agent may enhance the compatibility between the base polymer 25 and the channeling agent 35. This enhanced compatibility is facilitated by a lower viscosity of the blend, which may promote a more thorough blending of the base polymer 25 and channeling agent 35, which under normal conditions can resist combination into a uniform solution. Upon solidification of the entrained polymer 20 having a dimer agent added thereto, the interconnecting channels 45 which are formed there through have a greater dispersion and a smaller porosity, thereby establishing a greater density of interconnecting channels throughout the plug 55.

Interconnecting channels 45, such as those disclosed herein, facilitate transmission of a desired material, such as moisture, gas or odor, through the base polymer 25, which generally acts as a barrier to resist permeation of these materials. For this reason, the base polymer 25 itself acts as a barrier substance within which an active agent 30 may be entrained. The interconnecting channels 45 formed of the channeling agent 35 provide pathways for the desired material to move through the entrained polymer 10. Without these interconnecting channels 45, it is believed that relatively small quantities of the desired material would be transmitted through the base polymer 25 to or from the active agent 30. Additionally, wherein the desired material is transmitted from the active agent 30, it may be released from the active agent 30, for example in embodiments in which the active agent 30 is a releasing material, such as an antimicrobial gas releasing material.

FIG. 5 illustrates an active sheet or film 75 formed of the entrained polymer 20 used in combination with a barrier sheet 80 to form a composite, according to an aspect of the invention. The characteristics of the active sheet 75 are similar to those described with respect to the plug 55 shown in FIGS. 1 and 2. The barrier sheet 80 may be a substrate such as foil and/or a polymer (such as a container wall) with low moisture or oxygen permeability. The barrier sheet 80 is compatible with the active sheet 75 and thus, is configured to thermally bond to the active sheet 75, when the active sheet 75 solidifies after dispensing. FIG. 6 illustrates an embodiment in which the two sheets 75, 80 are combined to form a packaging wrap having active characteristics at an interior surface formed by the entrained polymer 20/active sheet 75, and vapor resistant characteristics at an exterior surface formed by the barrier sheet 80.

In one embodiment, the sheets 75, 80 of FIG. 5 are joined together to form an active package 85, as shown in FIG. 6. As shown, two laminates or composites are provided, each formed of an active sheet 75 joined with a barrier sheet 80. The sheet laminates are stacked, with each active sheet 75 facing the other, so as to be disposed on an interior of the package, and are joined at a sealing region 90, formed about a perimeter of the sealed region of the package interior.

Optionally, in any of the foregoing embodiments, the antimicrobial entrained polymer is in the form of a film that is disposed within a sealed food package. Optionally, the film may be adhered, e.g., using an adhesive, to an inner surface of the package. Alternatively, the film may be heat staked (without an adhesive) to the inner surface of the package. The process of heat staking film onto a substrate is known in the art and described in detail in U.S. Pat. No. 8,142,603, which is incorporated by reference herein in its entirety. The size and thickness of the film can vary. In certain embodiments, the film has a thickness of approximately 0.3 mm Optionally, the film may range from 0.1 mm to 1.0 mm, more preferably from 0.3 mm to 0.6 mm.

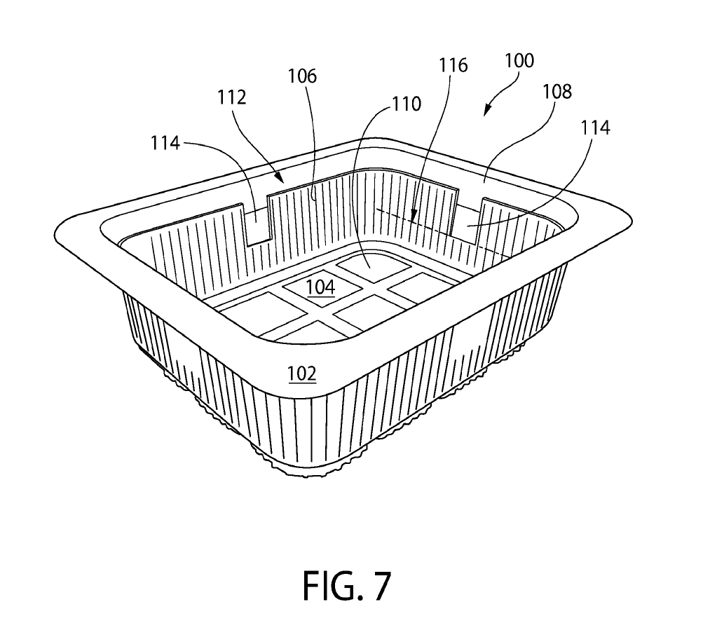

FIG. 7 shows a package 100 for storing fresh foodstuffs, e.g., produce or meat, in accordance with certain embodiments of the invention. The package 100 is shown in the form of a plastic tray 102. Although, other forms and materials are also contemplated as being within the scope of the invention. The tray 102 comprises a base 104, and sidewalls 106 extending vertically from the base 104 leading to a tray opening 108. The base 104 and sidewalls 106 together define an interior 110, e.g. for holding and storing fresh produce. The package 100 also includes a flexible plastic lidding film 112, which is disposed over and seals the opening 108. It is contemplated and understood that a wide variety of covers or lids may be used to close and seal the opening 108. Optionally, the cover or lid is transparent, such that the interior can be viewed. When a product (e.g., sliced tomatoes) is stored within the interior 110, empty space surrounding and above the product is herein referred to as “headspace” (not shown).

The package 100 further includes sections of antimicrobial entrained polymer film 114 disposed on the sidewalls 106. In the embodiment shown, there are four sections of such film 114, one section of film 114 per sidewall 106. The film 114 is preferably disposed at or near the top of the sidewall 106, proximal to the opening 108. At least a portion, although preferably most or all of each of the film sections 114 protrude above the midline 116 of the sidewall 106, the midline 116 being centrally located between the base 104 and the opening 108. It has been found that film placement at or towards the top of the package 100 has an effect on efficacy of the film sections 114, as such placement facilitates desirable distribution of released antimicrobial material into the headspace of the package 100. Placing the entrained polymer at too low of a height above the base 104, or beneath the food in the package, has been found not to provide desirable distribution of the released antimicrobial material in the headspace. If placement mass transfer of the antimicrobial is not optimal, some of the food product/good will not be adequately protected against the growth of microbes. Additionally, the food may undesirably react with and/or absorb the released antimicrobial material. As explained further below, it has been found that placing the film above the midline of the sidewall, preferably at a height of at least 67% or 75% or about 80% of the sidewall, facilitates achieving a desired antimicrobial gas release profile and headspace concentration.

Optionally, the entrained polymer film 114 is heat staked to the package (e.g., on the sidewall as described and shown vis-à-vis FIG. 7). Advantageously, heat staking could allow the film to permanently adhere to the sidewall without use of an adhesive. An adhesive may be problematic in some circumstances because it may release unwanted volatiles in the food-containing headspace. Aspects of a heat staking process that may be used in accordance with optional embodiments of the invention are disclosed in U.S. Pat. No. 8,142,603, as referenced above. Heat staking, in this instance, refers to heating a sealing layer substrate on the sidewall while exerting sufficient pressure on the film and sealing layer substrate to adhere the film to the container wall.

In certain embodiments, the antimicrobial entrained polymer film 114 may be connected to the surface of the lidding film 112 (or a lid) that is inside of the container, in place of the film sections 114 on the sidewall(s) 106, or in addition thereto. Alternatively, the antimicrobial entrained polymer film 114 may be incorporated into the composition of the lidding film 112 (or a lid).

In addition to placement of the film 114, another important factor is the release profile of the released antimicrobial material. As aforementioned, to ensure adequate shelf life, release of the agent must not all occur immediately; rather, release should be extended, sustained and predetermined to attain a desired shelf life.

In general, the polymer entrained with antimicrobial releasing agent is self-activating, meaning that release of the released antimicrobial gas is not initiated until the antimicrobial releasing agent is exposed to the selected material, e.g., moisture. Typically, moisture is not present in the interior, e.g., headspace, of the container prior to a food product being placed inside of the container. Upon placement, the food product generates moisture that interacts with the antimicrobial releasing agent entrained in the polymer, to generate the antimicrobial releasing agent in the headspace. In one embodiment, the container is sealed in a moisture tight manner to trap moisture within the container generated by moisture-exuding comestibles.

In certain embodiments, a controlled release and/or a desired release profile can be achieved by applying a coating to the active agent, e.g., using a spray coater, wherein the coating is configured to release the released antimicrobial agent within a desired time frame. The antimicrobial releasing agents may have different coatings applied thereon to achieve different release effects. For example, if a 14-day shelf life is desired, based on predetermined relative humidity of the package, the amount of selected material (moisture) present to trigger the antimicrobial releasing agent may be determined. Based on this determination, the agent may be coated with extended release coatings of varying thicknesses and/or properties to achieve the desired release profile. For example, some active agent will be coated such that it will not begin releasing released antimicrobial material until after one week, while other active agent will begin release almost immediately. Spray coating technology is known in the art. For example, pharmaceutical beads and the like are spray coated to control the release rate of active ingredient, e.g., to create extended or sustained release drugs. Optionally, such technology may be adapted to apply coatings to the active agent to achieve a desired controlled rate of release of antimicrobial gas.

Alternatively, a controlled release and/or desired release profile may be achieved by providing a layer, optionally on both sides of the film, of a material configured to control moisture uptake into the entrained polymer (which in turn triggers release of the released antimicrobial material). For example, the film may include a polymer liner, made e.g., from low density polyethylene (LDPE) disposed on either side or both sides thereof. The thickness of the film and liner(s) can vary. In certain embodiments, the film is approximately 0.3 mm thick and the LDPE liners on either side are each approximately 0.02 mm to 0.04 mm thick. The LDPE liners may be coextruded with the film or laminated thereon.

Alternatively, a controlled release and/or desired release profile may be achieved by modifying the formulation of the trigger of the antimicrobial releasing agent. For example, the trigger, when contacted by moisture, liquefies and then reacts with the active component (e.g., sodium chlorite) to cause release of the antimicrobial gas. The trigger may be formulated to liquefy upon contact with moisture at different rates. The faster the trigger liquefies, the faster the release of antimicrobial gas and vice versa. In this way, modification of the trigger is yet another vehicle provide a desired release rate of antimicrobial gas.

Any combination of the aforementioned mechanisms may be utilized to achieve desired release rates and release profiles of antimicrobial gas within a container headspace.

### Varied Release Rates Depending on Nature of Stored Food Product

The inventors have discovered that the desired release profile of chlorine dioxide gas in a container headspace may vary depending on the nature of the product that is stored. For example, the inventors have found that foods having a high water content appear to require a high burst of antimicrobial gas followed by a drop in headspace concentration during the storage period while foods having a more modest water content appear to respond well to a relatively steady headspace concentration over the storage period.

Non-limiting examples of food products that exude high amounts of moisture and that are more appropriately protected by a release profile having a quick burst of chlorine dioxide gas followed by a drop include sliced, diced or cut foods selected from the group consisting of: tomatoes, washed peppers, washed onions, water melon, honey dew, cantaloupe, strawberries, peaches, pineapple, oranges, seafood, meat and poultry. For such foods, an amount of the antimicrobial releasing agent is provided that releases the chlorine dioxide gas to preferably provide a headspace concentration of from 10 parts per million (PPM) to 35 PPM for a period of 16 hours to 36 hours, optionally from 15 PPM to 30 PPM for a period of 16 hours to 36 hours, optionally from 15 PPM to 30 PPM for a period of about 24 hours. Headspace concentration measurements may be obtained, for example, using a PORTASENS II gas detector from Analytical Technology, Inc. for readings taken with chlorine dioxide sensors placed within the package. The sensors may be one or more of 00-1004 Chlorine Dioxide, 0-1/5 PPM (2 PPM Std.), 00-1005 Chlorine Dioxide, 0-5/200 (20 PPM Std.) and 00-1359 Chlorine Dioxide, 0-200/1000 PPM (1000 PPM Std.), which are also from Analytical Technology, Inc. and are compatible with the PORTASENS II gas detector.

This type of “quick burst” (headspace concentration of from 10 parts per million (PPM) to 35 PPM for a period of 16 hours to 36 hours) appears to be required so that the chlorine dioxide gas, which dissolves in water, can stay ahead of the dissolution curve to provide sufficient antimicrobial effect during the spike in headspace concentration, to improve the shelf life of contaminated food over an approximately two-week period. Notwithstanding the characterization of the release as “quick burst,” it may still be considered controlled release because headspace concentration is still regulated to fall within a desired concentration over a given period, even if relatively “quick.” The inventors have found, for example, that the aforementioned headspace concentrations works well to significantly reduce the microbial count of contaminated sliced tomatoes over about thirteen days without bleaching the tomatoes. This is borne out by examples provided below.

Non-limiting examples of food products that exude moderate or low amounts of moisture are whole or minimally processed produce selected from the group consisting of: broccoli, brussel sprouts, cabbage, cucumbers, bananas, herbs, whole peppers, carrots, root vegetables and potatoes. For such foods, an amount of antimicrobial releasing agent releases the chlorine dioxide gas to preferably provide a headspace concentration of from 8 PPM to 15 PPM for a period of 13 days. Regardless of whether this exact headspace concentration is met, it is preferred that the antimicrobial releasing agents are provided in entrained polymer films, as described herein, for such low or moderate moisture exuding foods.

The aforementioned release profiles and headspace concentration assume the presence of moisture exuding food product in the package.

In either case (high moisture exuding or moderate/low moisture exuding foods), where the product is contaminated by at least one type of pathogen, the chlorine dioxide gas is provided in a headspace concentration over a determined time period to effectuate, after a span of 13 days from when the product is provided within the interior space and under storage conditions of 7° C., at least a 2 log base 10 reduction in colony forming units per gram (CFU/g), optionally at least a 3 log base 10 reduction in CFU/g, optionally at least a 4 log base 10 reduction in CFU/g of the at least one type of pathogen, without causing organoleptic degradation of the food product. Such organoleptic degradation may include bleaching or other discoloration of the food product.

Optionally, according to any embodiment, 700-950 mg of the antimicrobial releasing agent is effective when used in a 1 L container having 1.25 lbs of tomatoes stored therein. It is contemplated that proportional adjustment of the mass of antimicrobial releasing agent may be done according to changes in container volume and amount/type of contents.

### Applications of Invention for Non-Edible Goods

In another aspect, the invention is directed to use of entrained polymers comprising antimicrobial agents for use outside of food preservation applications. For example, the solutions disclosed herein may be adapted for use in sterilization of disposable medical devices, i.e., to reduce the bioburden of such devices when they are packaged. The primary difference between preservation of fresh food and medical devices is shelf life. Preservation of fresh food implicates a shelf life measured in days or weeks while maintaining sterility of packaged medical devices requires a shelf life measured in months or years. Accordingly, the release profile over time for one application versus the other will necessarily vary.

The invention will be illustrated in more detail with reference to the following Examples, but it should be understood that the present invention is not deemed to be limited thereto.

### EXAMPLES

### Example 1—Controlling Release of ClO₂ Gas

A storage temperature of 7° C. was chosen to replicate a storage temperature that is slightly elevated above ideal storage temperature (or to stimulate an inadvertent spike in temperature during storage, e.g., when refrigeration equipment breaks down for a few hours). Three packages similar to that shown in FIG. 7 were utilized in this experiment. All three included antimicrobial entrained polymer film sections placed substantially as shown in FIG. 7. The film was a three phase entrained polymer film including an antimicrobial releasing agent in the form of a powdered mixture comprising sodium chlorite (which produces chlorine dioxide gas), sulfuric acid clay (as a catalyst) and calcium chloride (as a humidity trigger). This powdered mixture is sold commercially by BASF under the name ASEPTROL and is described above.

The formulation for the film itself was a three phase formulation including 50% by weight of the aforementioned antimicrobial releasing agent in the form of the powdered mixture, 38% by weight ethyl vinyl acetate (EVA) as a base polymer and 12% by weight polyethylene glycol (PEG) as a channeling agent. This film formulation is described herein as X2597 and is considered one exemplary non-limiting embodiment of an entrained polymer according to an aspect of the disclosed concept. As described above, the antimicrobial releasing agent is triggered by moisture to release chlorine dioxide (ClO₂) gas as the released antimicrobial material. The film, as between the three packages, was the same formulation and dimensions. However, two of the films had external layers to control moisture uptake and one had no such layers. The film in Package A was sandwiched between coextruded layers of LDPE that were about 0.02 mm thick. The film in Package B was sandwiched between coextruded layers of LDPE that were about 0.04 mm thick. The film in Package C (the control) had no such polymer layers on either side of the film.

The ClO₂ levels in the packages were measured for 13 days with detection sensors calibrated for the desired concentration known to have an antimicrobial effect on most organisms. Results were as follows (values presented in ppm concentration of ClO₂).

| Day | Package A | Package B | Package C |
|---|---|---|---|
| 1 | 24 | 17 | 34 |
| 2 | 27 | 22 | 43 |
| 3 | 28 | 21 | 29 |
| 4 | 27 | 21 | 27 |
| 5 | 28 | 20 | 26 |
| 6 | 29 | 20 | 25 |
| 7 | 26 | 21 | 18 |
| 8 | 21 | 21 | 12 |
| 9 | 17 | 19 | 9 |
| 10 | 13 | 17 | 4 |
| 11 | 11 | 16 | 4 |
| 12 | 8 | 13 | 4 |
| 13 | 6 | 11 | 4 |

This Example demonstrates that Package B had the steadiest and most consistent release profile, attributable to the thicker polymer liner sandwiching the antimicrobial film, which controlled moisture uptake into the film. The release profile of Package B may be desirable for certain applications, for example, where the food product exudes a relatively modest amount of moisture, such as broccoli.

### Example 2—Geotrichum Growth Testing

A common cause of rejects for quality of tomatoes is Geotrichum candidum, a yeast-like mold that grows as a white fuzz. In this example, sliced tomatoes deliberately tainted with G. candidum were packaged and subjected to testing. A storage temperature of 7° C. was chosen to replicate a storage temperature that is slightly elevated above ideal storage temperature (or to stimulate an inadvertent spike in temperature during storage, e.g., when refrigeration equipment breaks down for a few hours).

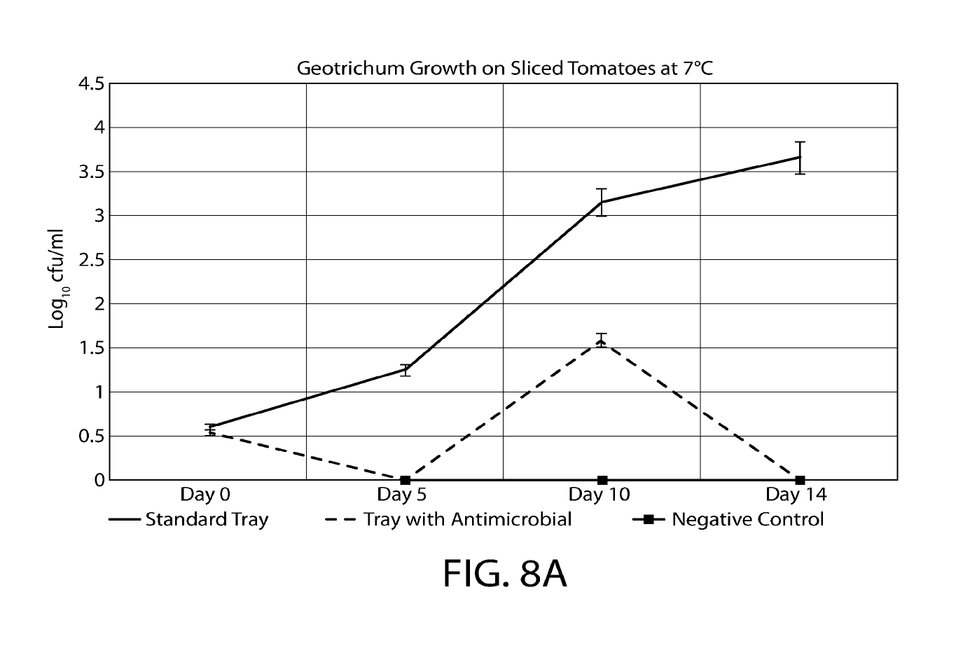

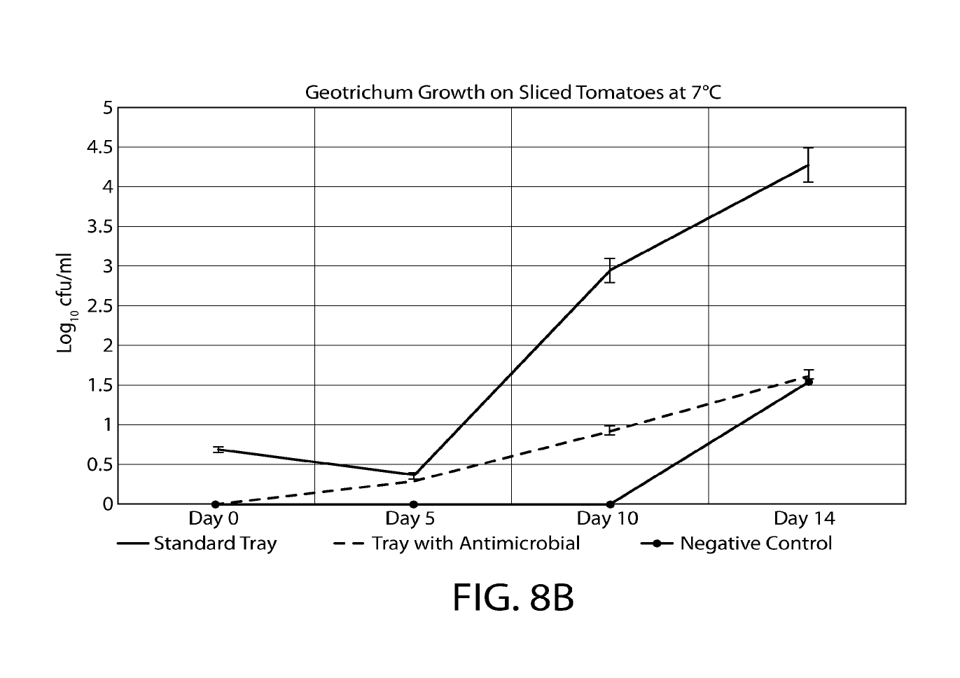

A package similar to that shown in FIG. 7, with the ClO₂-releasing antimicrobial film placed towards the top of the package, was used to store the contaminated sliced tomatoes. A second package, otherwise identical to the first except without the antimicrobial film, was used to store the contaminated sliced tomatoes. The results are provided on the graphs shown in FIGS. 8A and 8B. The results show conclusively that the antimicrobial film significantly inhibited growth of Geotrichum on the sliced tomatoes compared to the package without the film. In the package without the antimicrobial film, proliferation of Geotrichum on the sliced tomatoes was readily apparent to the naked eye. By contrast, the sliced tomatoes in the package with the entrained polymer ClO₂-releasing antimicrobial film appeared fresh, with no visible signs of Geotrichum growth. This is further notable given the suboptimal 7° C. storage conditions for the 14-day test.

It should be understood that examples on tomatoes were merely exemplary and that other produce and fresh foods (e.g., meat) may be used in accordance with the invention. It should be further understood that while chlorine dioxide is one preferred released antimicrobial material, other released antimicrobial materials are within the scope of the invention and may be preferred for other applications.

### Example 3—Antimicrobial Film Location Testing

Entrained polymer film (X2597 film, described above) was placed in the headspace of a tray at various height positions on the sidewalls to test the effectiveness of various antimicrobial film locations/positions, as well as various sampling locations. The abbreviation “MCT” as used herein refers to Maxwell Chase Technologies, LLC of Atlanta, Ga. The abbreviation “FPT” refers to FRESH—R-PAX® trays of Maxwell Chase Technologies, LLC.

The following materials were used in this example:

16 - 1 g X2597 Film Strips Lot #02116A030A (CSP Technologies - Auburn, AL).
66 Tomatoes (5 × 5 red tomatoes purchased from grocery store the day of the experiment).
24 MCT FPT 125D Trays (Maxwell Chase Technologies - Atlanta, GA) having a bottom
surface and an opposite opening, with four sidewalls extending vertically from the bottom
surface. The sidewalls had a length of 10″ and height of 3 5″8 (measured from the bottom
surface).
24 plastic holders (Made from cut MCT FPT125D trays.)
Polypropylene (PP) lidding film approx. 50-gauge oriented polypropylene cast/ 1 mil. Cast
Polypropylene (0.00152″ thick) app. 90 cc/100 in²/day OTR, 0.8 gm/100 in²/day WVTR (MCT -
Atlanta, GA)
MCT-MTS Manual Tray Sealer at 375° F. (MCT Atlanta, Ga).
SABER Tomato Hand-Slicer 7/32″ slices (Prince Castle, Carol Stream, IL).
ATI C16 Portable Gas Analyzer (Analytical Technology Inc. Collegeville, PA).
ClO₂ Sensor #00-1425 1/5 (ATI Collegeville, PA).
ClO₂ Sensor #00-1004 1/5.
ClO₂ Sensor #00-1005 5/200.
ClO₂ Sensor #00-1359 200/2000.
Tempure Scientific Top Mount Laboratory Refrigerator (Model #LP-75-HG-TP) equipped
with a Dixell XR40CX computer control set at 7 C. temperature with high of 8° C. and low of
6° C. cooling setting.
2 Sets of CPC #3438400 Quick-Disconnect Valves with compression fittings per mason jar
(McMaster-Carr (MCM) #5012K122).
Flex ® GP 70 3/16″ ID, ¼″ OD black PVC tubing (MCM #5231K35).
011 Buna-N O-ring, oil resistant, round profile (MCM #9408K41).
Xacto Knife.

The MCT FPT125D (¼ steam size, deep white polypropylene) trays were modified as follows. Three holes approximately 8.5 mm wide and 2 cm apart were made into the MCT FPT125D trays with an Xacto knife. Edges of the hole were cleaned and the CPC valves were screwed into the holes with an o-ring on both sides, and the compression fitting tightening down the 2 rings. Both valves were placed with QDV on the outside of the lid and container to allow for the automatic closing valves to be on the outside for sampling purposes.

Flex® GP 70 3/16″ ID, ¼″ OD black PVC tubing(MCM#5231K35) was used on both intake and outtake ports of the C16 Portable Gas Analyzer, as well as the other end of the CPC #3438400 Quick-Disconnect Valves with compression fittings to connect to the trays to sample the headspace in the trays.

CSP film samples were cut from the same strip of film and same width. Then, each sample was weighed to 1.000 g and connected to a sidewall of the tray with a plastic piece to hold it in place. There were two samples in each tray, which resulted in 2 g of CSP film per tray. Each of the samples was connected to a different sidewall of the tray.

The tomatoes were sliced using the hand-slicer with the calyx facing down. The ends were discarded. About 7 slices of tomatoes were placed on the bottom surface of each tray.

The manual sealer was heated to 375° F., and each tray with tomatoes therein was placed on the respective sealing plate. Lidding/Sealing film was placed over the tray, the sealing handle was pressed down and held for approximately 1-2 seconds to cover/seal the tomatoes inside the tray.

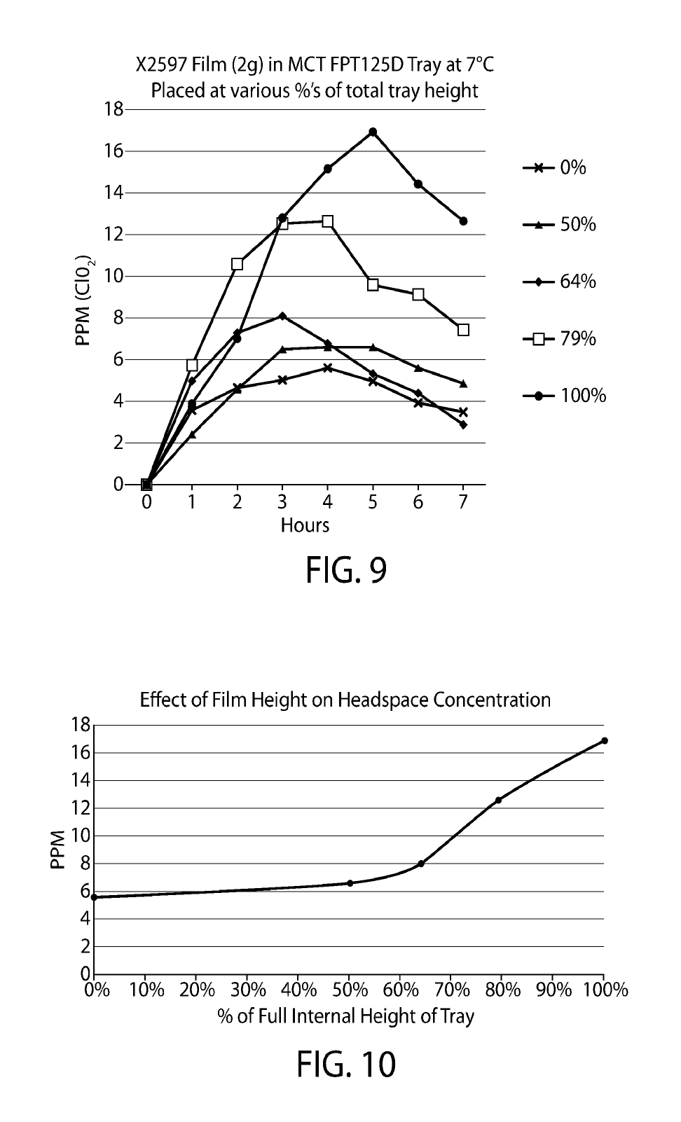

For each of the trays, the ClO₂ release rate was measured in one-hour intervals over an 11-hour period. FIG. 9 shows the release of ClO₂ (ppm) corresponding to various positions of the CSP film in the tray, i.e., at 0%, 50%, 64%, 79% and 100% height from the bottom surface based on total height of the sidewall. These respective heights are measured from the midline of the film. FIG. 10 shows the effect of the CSP film height on headspace concentration.

The results indicate that varying the height of the CSP film in the tray has an effect on the presence of ClO₂ in the headspace. From the bottom of the tray (0%) to the mid-point (50%-approximately 2 inches up the sidewall in this particular non-limiting example), there was only a small, e.g., insignificant change in headspace concentration. However, from the mid-point to the top of the tray, the increase in height resulted in a significant increase in concentration. The concentration doubled from a position at 64% of the total height to the top of the tray (100%). The data indicates that in order to maximize the headspace concentration of ClO₂ for optimum effectiveness and/or to minimize the amount of film required, the placement of the film should be preferably in the top 20% of the tray, i.e., positioned at a vertical height that is 80% to 100% of the total height of the sidewall measured from the bottom surface, and should be placed at least at 64% of the total height of the sidewall of the tray.

### Example 4—Use of Quick Burst Release Profiles to Kill Pathogens

The effectiveness of reducing the level of Listeria monocytogenes, E. coli, and Salmonella, was evaluated for CSP ClO₂ film applied to an upper portion of a tray as compared to control trays absent of the CSP ClO₂ film.

CSP ClO₂ emitting films, designated formulation X2597 (described above), at 0.3 mm thickness were used. This formulation was designed to have a fast ClO₂ release profile and did not use an overlying polyethylene layer to reduce the moisture uptake rate into the film. As described above, the X-2597 film is a three phase formulation including 50% by weight of antimicrobial releasing agent, 38% by weight ethyl vinyl acetate (EVA) as a base polymer and 12% by weight polyethylene glycol (PEG) as a channeling agent. Trays with either 4 grams or 3 grams of film per tray were used. The tomatoes in the tray were each inoculated with three pathogens, i.e., Listeria monocytogenes, E. coli and Salmonella.

The following materials were used in this example.

250 Tomatoes-category 5 × 5 (extra for waste) (5 cases 50/cases)
Tomato hand-slicer (Prince Castle)
Manual sealer set at 375° F. (Maxwell Chase Tech.)
Polypropylene lidding film Approx. 90 OTR (Maxwell Chase Tech)
Listeria monocytogenes 5 strain cocktail inoculums (Food Isolates)
Salmonella 5 strain cocktail (Food Isolates)
E. coli O157:H7 5 strain cocktail (Food Isolates)
Sterile Dilution water and tubes
Sterile forceps
Alcohol beaker and flame for sterilizing forceps
Sterile surgical knives
10 FPT 125D Trays (¼ steam sized white polypropylene trays) w/
1 g ClO₂ film on each upper corner
10 FPT 125D Trays (¼ steam sized white polypropylene trays) w/
0.75 g ClO₂ film on each upper corner
10 FPT 125D Trays (¼ steam sized white polypropylene trays)
designated - MCT
4 Un-inoculated Trays designated - UN
Refrigerator set at 7° C.
564 MOX Plates (60 day 0.168 days 5, 8, 12) designated - List.
564 XLD plates (60 day 0.168 days 5, 8, 12) designated - Sal.
564 PCA plates (60 day 0.168 days 5, 8, 12) designated - APC
564 MAC plates (60 day 0.168 days 5, 8, 12) designated - E. coli
Enrichment broth for corresponding pathogens
Extra plates for streak verification

Salmonella, Listeria monocytogenes, and E. coli O157:H7 5 strain cocktails were prepared, mixed and kept overnight. The target was to achieve a 5-log inoculation of each pathogen on the tomatoes. The inoculated tomatoes had 10⁹ CFU pathogen/ml inoculum. Inoculations were plated for verification and initial levels.

A solution of 200 ppm free chlorine solution was prepared using lukewarm water. The slicer was immersed in the solution for 2 min, and then rinsed with tap water.

A 200-ppm free chlorine solution was prepared using warm water (approximately the same temperature as for the tomatoes). The tomatoes were placed in tap water first, then the chlorine solution for 2 minutes, and rinsed with tap water. The tomatoes were sliced using the hand-slicer with the calyx facing down. The ends were discarded such that there were 42 slices packed into each tray (6 tomatoes by 7 slices/tomato).

Eighteen (18) tomato slices within each tray were spot inoculated with the Salmonella, Listeria monocytogenes, and E. coli (6 each) inoculums to achieve a triplicate analysis in each tray. The 18 tomato slices selected were identified by marking each slice with a Sharpie adjacent to the area to be inoculated. The inoculum was vortexed and 10 μl of inoculum was quickly withdrawn with a sterile pipette tip and micro pipetted onto the two slices marked at the top. This was repeated twice more per tray per pathogen.

The manual sealer was heated to 375° F. Each tray was placed on the sealing plate and the lidding film was pulled over the tray. The sealing handle was depressed and held in place for approximately 1-2 seconds. After sealing, each tray was checked to verify that the lidding film was fully attached to the tray.

The test trays were analyzed on days 0, 5, 8 and 12. For each tray, there were a total of three samples for each pathogen, three pathogens per tray and three APC (aerobic plate count) samples were taken from each tray. Each sample consisted of two slices taken using sterile forceps. The two slices were weighed into the sterile stomacher bag (weight was approximately 40-50 g) and three times the amount of sterile Peptone water was added. The tomatoes were stomached at 260 rpm for 1 minute. The necessary dilutions were then prepared (˜3) from the homogenate and duplicate spread plated onto the corresponding PCA, MOX, SMAC, or XLD plates.

Data was calculated as colony forming units (CFU) per gram. CFU values were converted to log values for data analysis. Data was averaged per tray and per sample type. The following is a summary of the tests that were conducted on respective days. The term “CSP3” refers to trays using 3 g of X2597 film and the term “CSP4” refers to trays using 4 g of X2597 film.

Day 0: 1 MCT tray inoculated w/3 Salmonella, 3 E. coli, 3 Listeria and 3 APC tests/tray=12 tests; 1 CSP4 tray inoculated w/3 Salmonella, 3 E. coli, 3 Listeria and 3 APC tests/tray=12 tests; 1 CSP3 tray inoculated w/3 Salmonella, 3 E. coli, 3 Listeria and 3 APC tests/tray=12 tests; 1 UN tray not inoculated (Negative Control)×4 tests (sal, E. coli,Lm,APC)/tray=4 tests. Cumulatively, this was a total of 40 tests.

Day 5: 3 MCT tray inoculated w/3 Salmonella, 3 E. coli, 3 Listeria and 3 APC tests/tray=36 tests; 3 CSP4 tray inoculated w/3 Salmonella, 3 E. coli, 3 Listeria and 3 APC tests/tray=36 tests; 3 CSP3 tray inoculated w/3 Salmonella, 3 E. coli, 3 Listeria and 3 APC tests/tray=36 tests; 1 UN tray not inoculated (Negative Control)×4 tests (sal, E. coli,Lm,APC)/tray=4 tests. Cumulatively, this was a total of 112 tests.

Day 8: 3 MCT tray inoculated w/3 Salmonella, 3 E. coli, 3 Listeria and 3 APC tests/tray=36 tests; 3 CSP4 tray inoculated w/3 Salmonella, 3 E. coli, 3 Listeria and 3 APC tests/tray=36 tests; 3 CSP3 tray inoculated w/3 Salmonella, 3 E. coli, 3 Listeria and 3 APC tests/tray=36 tests; 1 UN tray not inoculated (Negative Control)×4 tests (sal, E. coli,Lm,APC)/tray=4 tests. Cumulatively, this was a total of 112 tests.

Day 12: 3 MCT tray inoculated w/3 Salmonella, 3 E. coli, 3 Listeria and 3 APC tests/tray=36 tests; 3 CSP4 tray inoculated w/3 Salmonella, 3 E. coli, 3 Listeria and 3 APC tests/tray=36 tests; 3 CSP3 tray inoculated w/3 Salmonella, 3 E. coli, 3 Listeria and 3 APC tests/tray=36 tests; 1 UN tray not inoculated (Negative Control)×4 tests (sal, E. coli,Lm,APC)/tray=4 tests. Cumulatively, this was a total of 112 tests.

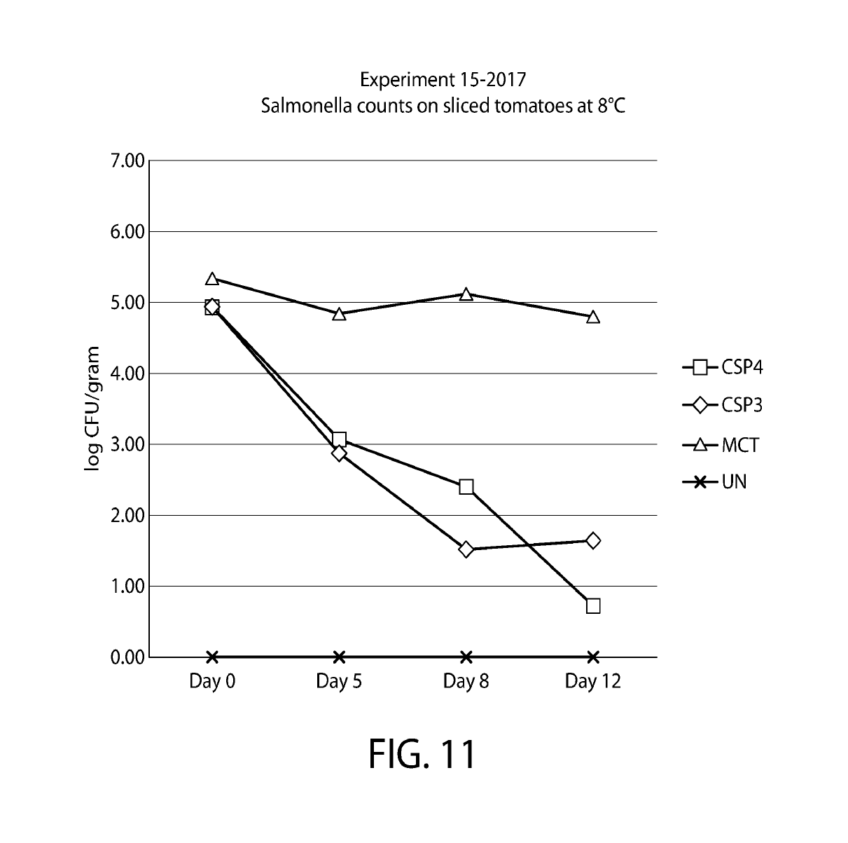

In all, this experiment cumulatively included a total of 376 tests (94 Salmonella, 94 E. coli, 94 Listeria, 94 APC). Results are shown in FIGS. 11-13.

FIG. 11 shows that there was a decline in Salmonella after Day 0 and stayed in decline until day 12 for the CSP3 trays, and continued for the CSP4 trays. Each of these samples showed a reduction in Salmonella counts of at least 1.8 logs on day 5, 2.5 logs for day 8, and 3 logs for Day 12 respectively. This demonstrates a 99.9% reduction in Salmonella after 12 days in the CSP trays.

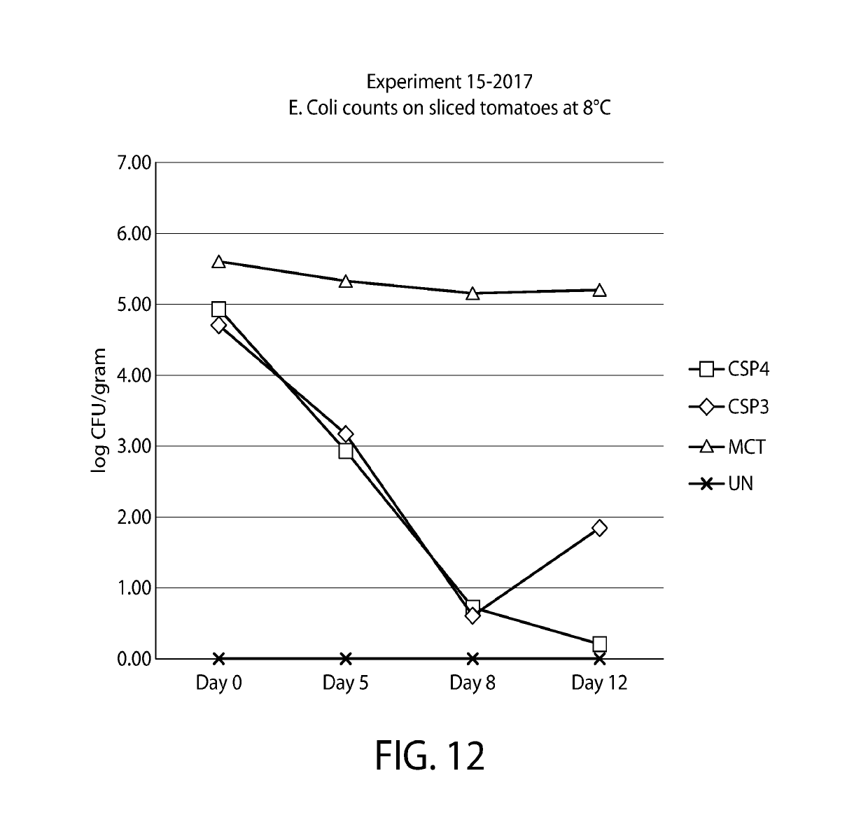

FIG. 12 shows results for E. coli that are similar to the Salmonella results. A decline in E. coli after Day 0 resulted in a reduction of at least 2 logs on day 5, 4 logs on day 8, and 3 logs on day 12. Similar to FIG. 11 for Salmonella, FIG. 12 shows an increase for the CSP3 tray on Day 12. It was determined that there was a 99.9% reduction in E. coli after a 12-day period.

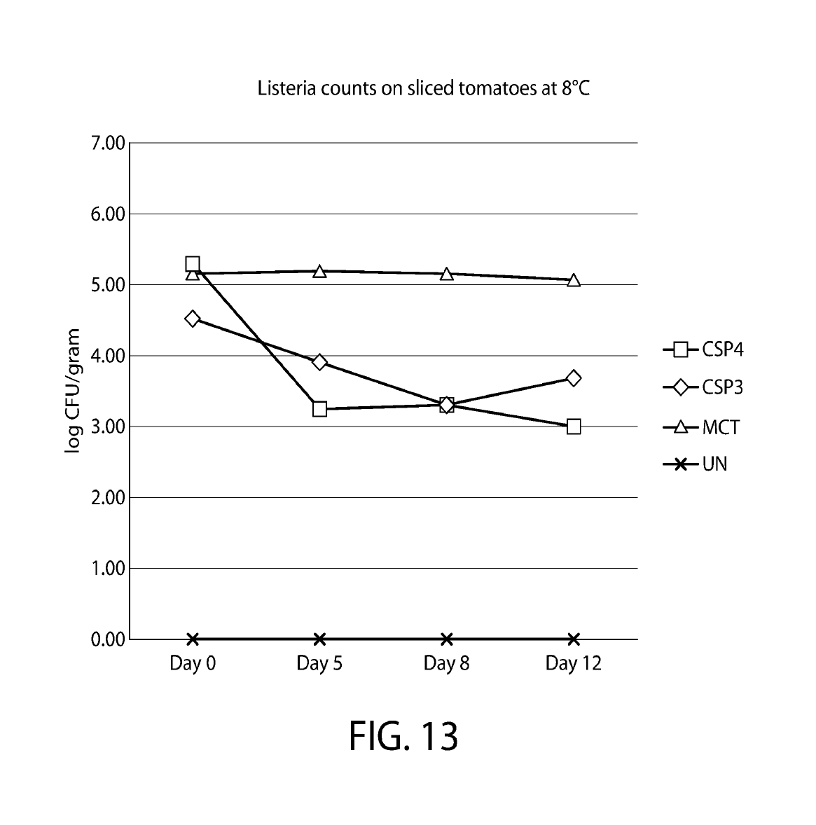

FIG. 13 shows that the CSP film also reduced Listeria by 1 log over 12 days of shelf life. This is consistent on every day samples were obtained, and demonstrated a 90% reduction of Listeria monocytogenes consistently for 12 days.

These results demonstrate the effectiveness of the CSP trays (according to optional aspects of the invention) with sliced tomatoes over a 12-day storage period to reduce the amounts of Salmonella, E. coli, and Listeria inoculated on the tomato slices and stored at 8° C. This is not a normal storage condition, but it simulates potential abuse within the cold chain that is noted in food safety storage practices as being the major cause of spoilage and pathogen growth. The use of these trays can contribute to reducing the potential for pathogens growth to harmful levels in sliced tomatoes.

### Example 5—Quick Burst Antimicrobial Gas Release Curves

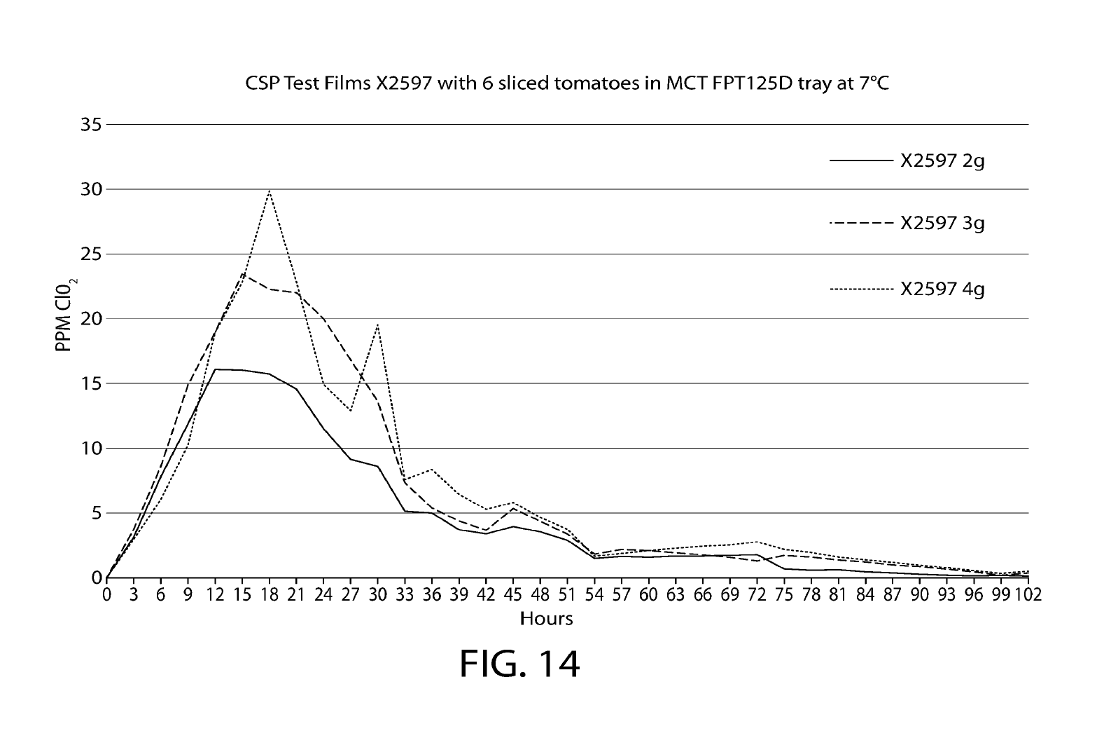

As described in Example 4, above, trays using 3 g or 4 g of X2597 film demonstrated significant activity in inhibiting pathogenic growth and proliferation over the testing period. The film formulations were configured to provide a quick burst release profile, as discussed elsewhere in this specification. FIG. 14 provides release curves for the 3 g and 4 g versions that were used in Example 4. FIG. 14 also provides a release curve for trays that used only 2 g of film.

As FIG. 14 shows, the trays using 4 g of film (CSP4) peaked at approximately 30 ppm of ClO₂ at about hour 18, while holding above 10 ppm between about hour 6 to hour 33. The trays using 3 g of film (CSP3) peaked at approximately 23 ppm of ClO₂ at about hour 15, while holding above 10 ppm between about hour 6 to hour 33. As stated above in Example 4, these embodiments provided sufficient headspace concentration to achieve a desired microbial kill and did so without bleaching the tomatoes.

FIG. 14 also shows a release curve for trays using 2 g of film. As the curve shows, that embodiment peaked at approximately 16 ppm of ClO₂ between hours 12 and 18. However, that curve shows that ClO₂ concentration only held above 10 ppm between about hours 8 to 26. In some circumstances, this concentration and release curve may provide sufficient antimicrobial effect, but in this instance, this concentration was not preferred (albeit is still within the scope of optional aspects of the disclosed concepts).

While the invention has been described in detail and with reference to specific examples thereof, it will be apparent to one skilled in the art that various changes and modifications can be made therein without departing from the spirit and scope thereof.

What is claimed is:

1. A package for inhibiting or preventing growth of microbes and/or for killing microbes in a closed container having a product located therein, the package comprising:
a. a closed container defining an interior space therein;
b. a product provided within the interior space;
c. a headspace formed within a volume of the interior space that is not occupied by the product; and
d. an antimicrobial releasing agent disposed within the interior space, the antimicrobial releasing agent releasing chlorine dioxide gas into the headspace by reaction of moisture with the antimicrobial releasing agent, wherein the antimicrobial releasing agent is provided in at least one entrained polymer article located within the interior space, the entrained polymer article comprising a monolithic material that includes a base polymer, the antimicrobial releasing agent and a channeling agent, wherein the monolithic material features channels though the entrained polymer formed of the channeling agent.

2. The package of claim 1, wherein at the time the product is provided within the interior space, the product is contaminated by at least one type of pathogen, the antimicrobial releasing agent providing a controlled release of chlorine dioxide gas to effectuate, after a span of 13 days from when the product is provided within the interior space and under storage conditions of 7° C., at least a 2 log base 10 reduction in colony forming units per gram (CFU/g), of the at least one type of pathogen.

3. The package of claim 2, wherein the at least one pathogen is selected from the group consisting of: Salmonella, E. coli, Listeria and Geotrichum.

4. The package of claim 1, wherein the product is a food product.

5. The package of claim 2, wherein the product is a food product, the amount of antimicrobial releasing agent and/or chlorine dioxide gas being present in an amount sufficient to effectuate the at least 2 log base 10 reduction in CFU/g of the at least one type of pathogen, without causing organoleptic degradation of the food product.

6. The package of claim 1, wherein the product exudes the moisture that reacts with the antimicrobial releasing agent to release the chlorine dioxide gas.

7. (canceled)

8. The package of claim 1, wherein the at least one entrained polymer is provided as a film having a thickness of from 0.1 mm to 1.0 mm.

9. The package of claim 1, wherein the container comprises a base and one or more sidewalls extending vertically from the base leading to a top opening and a cover that closes and/or seals the top opening to make the closed container.

10. The package of claim 9, wherein the at least one entrained polymer is provided as a film having a thickness of from 0.1 mm to 1.0 mm, the film being disposed on at least one sidewall, the at least one sidewall having a sidewall midline that is equidistant from the base and the opening, the film having a film midline that is equidistant from a top edge and a bottom edge of the film, wherein the film midline is located at least as high as the sidewall midline.

11. The package of claim 1, wherein the antimicrobial releasing agent is a powdered mixture comprising an alkaline metal chlorite.

12. The package of claim 11, wherein the powdered mixture further comprises at least one catalyst and at least one humidity trigger.

13. The package of claim 1, wherein the interior space has a volume of from 0.5 L to 10.0 L.

14. The package of claim 1, wherein the product is a food product that is sliced, diced or cut and is selected from the group consisting of: tomatoes, washed peppers, washed onions, water melon, honey dew, cantaloupe, strawberries, peaches, pineapple, oranges, seafood, meat and poultry.

15. (canceled)

16. (canceled)

17. (canceled)

18. (canceled)

19. (canceled)

20. (canceled)

21. (canceled)

22. The package of claim 1, wherein the antimicrobial releasing agent is provided in an amount sufficient to release the chlorine dioxide gas to provide a headspace concentration of from 8 PPM to 15 PPM for a period of 13 days.

23. The package of claim 22, wherein the food product is whole or minimally processed produce selected from the group consisting of: broccoli, brussel sprouts, cabbage, cucumbers, bananas, herbs, whole peppers, carrots, root vegetables and potatoes.

24. (canceled)

25. (canceled)

26. (canceled)

27. A package for inhibiting or preventing growth of microbes and/or for killing microbes in a closed container having a product located therein, the package comprising:
a container, comprising:
a base;
a top opening;
one or more sidewalls extending in a vertical direction from the base to the top opening;
an interior space formed by the one or more sidewalls;
a headspace formed by the interior space that is not occupied by the product; and
a cover to close and/or seal the container;
at least one entrained polymer article located within the interior space, comprising: a monolithic material, comprising:
a base polymer;
a channeling agent; and
an antimicrobial releasing agent capable of releasing a released antimicrobial gas; and
moisture present in the interior space to activate the release of the released antimicrobial gas.

28. (canceled)

29. (canceled)

30. The package of claim 27, wherein the at least one entrained polymer article is a film, the film having a thickness of from 0.1 mm to 1.0 mm, the film being disposed on at least one sidewall, the at least one sidewall having a sidewall midline that is equidistant from the base and the opening, the film having a film midline that is equidistant from a top edge and a bottom edge of the film, wherein the film midline is located at least as high as the sidewall midline.

31. The package of claim 1 wherein the product is a food product, wherein the food product exudes moisture that activates the antimicrobial releasing agent to release chlorine dioxide gas in the headspace.

32. The package of claim 31, wherein the antimicrobial releasing agent is provided in an amount sufficient to release the chlorine dioxide gas to provide a headspace concentration of from 10 parts per million (PPM) to 35 PPM for a period of 16 hours to 36 hours.

33. The package of claim 31, wherein at the time the food product is provided within the interior space, the product is contaminated by at least one type of pathogen, the antimicrobial releasing agent providing a controlled release of chlorine dioxide gas effectuating, after a span of 13 days from when the product is provided within the interior space and-under storage conditions of 7° C., at least a 2 log base 10 reduction in colony forming units per gram (CFU/g) of the at least one type of pathogen, without causing organoleptic degradation of the food product.

34. (canceled)

35. The package of claim 33, wherein the at least one pathogen is selected from the group consisting of: Salmonella, E. coli, Listeria and Geotrichum.

36. The package of claim 1, wherein the antimicrobial releasing agent is provided in an amount that releases the chlorine dioxide gas to provide a headspace concentration of from 10 parts per million (PPM) to 35 PPM for a period of 16 hours to 36 hours.

37. The package of claim 9, wherein the at least one entrained polymer article is provided on the cover.

38. The package of claim 9, wherein the cover is a lid or lidding film and wherein the at least one entrained polymer article is incorporated into the lidding film or lid.

39. The package of claim 1, wherein the entrained polymer article comprises the channeling agent in an amount at least 2% by weight of the entrained polymer article.

40. The package of claim 27, wherein the entrained polymer article comprises the channeling agent in an amount at least 2% by weight of the entrained polymer article.
